(19) United States
(12) Patent Application Publication
(10) Pub. No.: US 2002/0030006 A1
(43) Pub. Date: Mar. 14, 2002

(54) Tubular filter element

(76) Inventor: Walter O. Beck, Ostfildern (DE)

Correspondence Address: STRIKER, STRIKER & STENBY, 103 East Neck Road, Huntington, NY, 11743, US

(21) Appl. No.: 09/912,204

(22) Filed: Jul. 24, 2001

(30) Foreign Application Priority Data
Sep. 8, 2000 (DE) 100 44 579.9

(51) Int. Cl. B01D 33/48

(52) U.S. Cl. 210/411

(57) ABSTRACT

A tubular filter element has a filtering material extending over a whole length and having in its interior a hollow chamber so that during a filtering operation the filtering material is loaded from outside with a medium to be filtered which passes through the filtering material from outside inwardly to the hollow chamber, a back wash aid arranged in the hollow chamber, a coaxial inner tube located in the hollow chamber of the filtering material and arranged at least at some locations with a distance from the filtering material so as to form at least one intermediate chamber, the inner tube having a tubular wall and being provided at least substantially in a lower longitudinal region with throughgoing passages extending through the tube wall and formed so that, for back washing of the filtering material a back washing medium is supplied opposite to a filtering operation on the one hand into an interior of the inner tube and through the throughgoing passages and on the other hand also into the at least one intermediate chamber and from the latter from inside outwardly through the filtering material.

### BACKGROUND OF THE INVENTION

The present invention relates generally to tubular filter elements.

One of the tubular filter elements is disclosed for example in the German patent document DE 42 42 991. This tubular filter element has an inner tube for filling the hollow chamber in a filter material in form of a tubular cylinder body, wherein the inner tube is closed at the upper end, and between the inner tube and the filter material a ring shaped intermediate space is open at the upper end of the filter element. Such a tubular filter element is back washed and cleaned with pressure air so that, pressure air is introduced into the upwardly open ring-shaped intermediate chamber between the inner tube and the filter element, passes through the filter material from inside outwardly, and therefore releases it from the dirt.

It has been shown that, depending on the material from which the cylindrical filter body is composed, a more or less unsuitable backwash of the same is performed in this manner, since during back washing, whether it is performed by air or by water and/or air, the back washing medium is aspirated substantially fast at the upper part of the filter element and back wash the same. With increasing cleaning of this upper region, the resistance increases so that the quantity of the back washing medium which is available in this upper region can pass then the filter element without loading, back washing and cleaning the central or lower part of the filter material located below.

Depending on the used filter material, this disadvantage is greater or smaller. First of all, with a filter material which is composed of folded, in particular plissed or wound material, the back wash efficiency is particularly unsuitable, since these materials have large surfaces and low resistance, so that the filter element on the upper longitudinal region is back washed and cleaned relatively fast with the resulting resistance reduction with the disadvantage that the back washing medium no longer back washes and cleans the longitudinal region of the filter element located below.

### SUMMARY OF THE INVENTION

Accordingly, it is an object of the present invention to provide a tubular filter element of the above mentioned general type which is formed so that a substantially uniform back washing can be provided over the whole tube length.

In keeping with these objects and with others which will become apparent hereinafter, one feature of present invention resides, briefly stated, in a tubular filter element, in which the inner tube at least substantially in its lower longitudinal region has throughgoing passages in the tubular wall, such as openings, boreholes and the like, and for back washing the filter material a back washing medium, in particular water and/or air, is supplied opposite to the filter operation on the one hand into the interior of the inner tube and through the throughgoing passages and on the other hand also into the at least one intermediate chamber and from there inwardly and outwardly through the filter material.

When the filter element is designed in accordance with the present invention, it avoids the disadvantages of the prior art. The filter element in accordance with the present invention is back washed over its whole length, and the accumulated dirt is removed by the back washing. A substantially uniform back washing of the whole tube length is provided, and this is true for such a filter material as folded, in particularly pleased material, in particular fabric, used as a filter medium. During back washing with the back washing medium composed of water and/or air, it is introduced on the one hand into the interior of the inner tube, whereby the back washing medium can not penetrate the longitudinal region of the inner tube whose wall is throughgoing and has no throughgoing openings. Only when the back washing medium pumped into the interior of the inner tube reaches the longitudinal region of the inner tube which is provided in the wall with the through going passages, the back washing medium is supplied through the throughgoing passages into the intermediate chamber and from it inwardly and outwardly through the filter element which is thereby back washed and cleaned.

Moreover, the back washing medium is pumped into at least one intermediate chamber which is formed between the inner tube and the filter material. Thereby with this part of the back washing medium, the upper longitudinal region of the filter material which is back washed and cleaned, since in this region the back washing medium is supplied from the intermediate chamber from inside outwardly through the filter material. With such tubular filter elements which have a great length, for example of 2 m or more, with the present invention it is possible to provide over the whole tube length a substantially uniform back washing and cleaning of the filter material. The pressure of the back washing medium is distributed over the whole length from above downwardly uniformly. Because of the obtained back washing and the cleaning of the whole tube length, the filter element after the back washing during the filtering operation is again in the position to provide a filter action over the whole length. Thereby the service life of the filter material in accordance with the present invention is substantially increased. First of all, the expenses for reclaiming of the inventive filter elements are low. Also, the filter elements which are in operation can be upgraded with low expense in the sense of the present invention.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a schematic cross-section of substantial parts of a filter element in accordance with a first embodiment of the present invention;

FIG. 2 is a view showing a schematic cross-section taken along the line 11-11 in FIG. 1;

FIGS. 3 and 4 are views each showing a section in FIG. 2 corresponding to a second and a third embodiment;

FIG. 5 is a view showing a schematic section of a filter element which substantially corresponds to that of FIG. 1 but is formed in accordance with a fourth embodiment of the present invention;

FIG. 6 is a view showing the section taken along the line VIVI in FIG. 5;

FIG. 7 is a view schematically showing a section of a filter element which substantially corresponds to that of FIG. 1 but is formed in accordance with a fifth embodiment; and

FIG. 8 is a view showing a section taken along the line VIII-VIII in FIG. 7.

### DESCRIPTION OF THE PREFERRED EMBODIMENTS

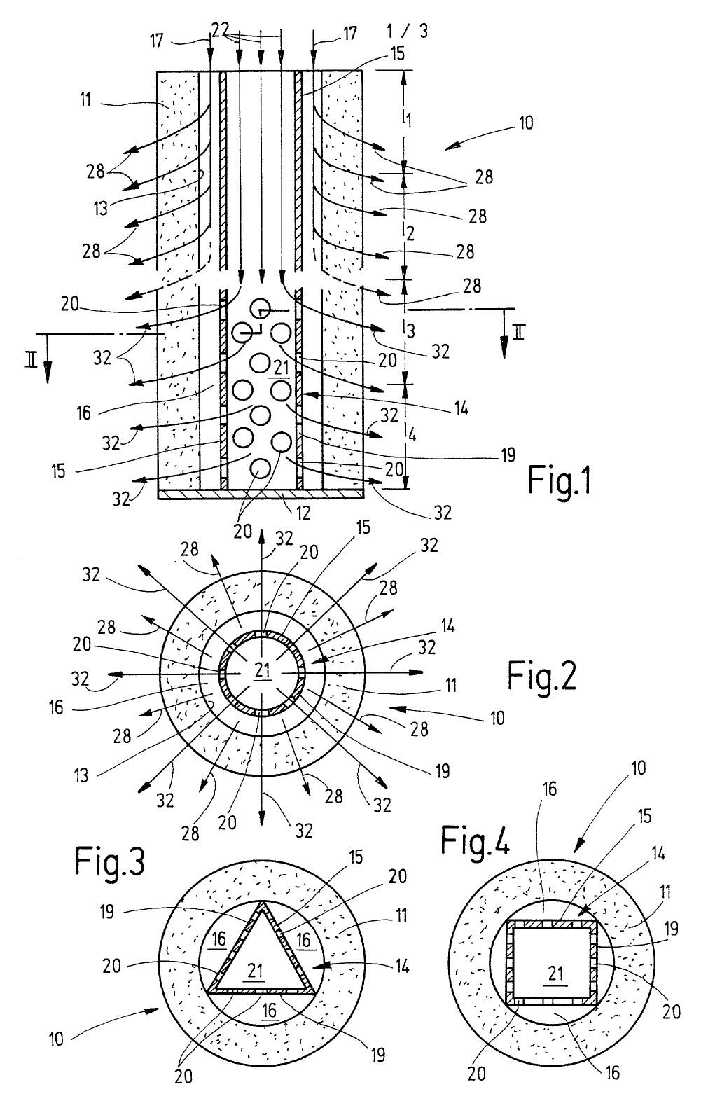

FIGS. 1 and 2 shows a first example of a tubular filter element 10 which has a filtering material 11 in form of a tubular cylindrical body extending over the whole length of the filter element 10. The filter element 10 has a considerable length, which can be for example 2 m. The whole tube length is subdivided in FIG. 1 into four individual and substantially uniformly large longitudinal portions 11, 12, 13, and 14. The filter element 10 has the lower end which in FIG. 1 is closed with a closure 12. A hollow chamber 13 is provided in the interior of the tubular cylinder body of the filtering material 11. During filtering operation, the filter element 10 is loaded outwardly at the outer side of the filtering material 11 with a filtering medium, for example a liquid. The liquid passes through the filtering element 11 from outside inwardly to the hollow chamber 13 and it moves the contained particles, in particular dirt, which accumulate on or in the filtering material 11. In a predetermined time interval, such a filter element 10, in particular the filtering material 11, is cleaned and regenerated so that, a back washing with a back washing medium, in particular water and/or air or gas, is supplied opposite to the filtering operation from inside outwardly through the filtering material 11.

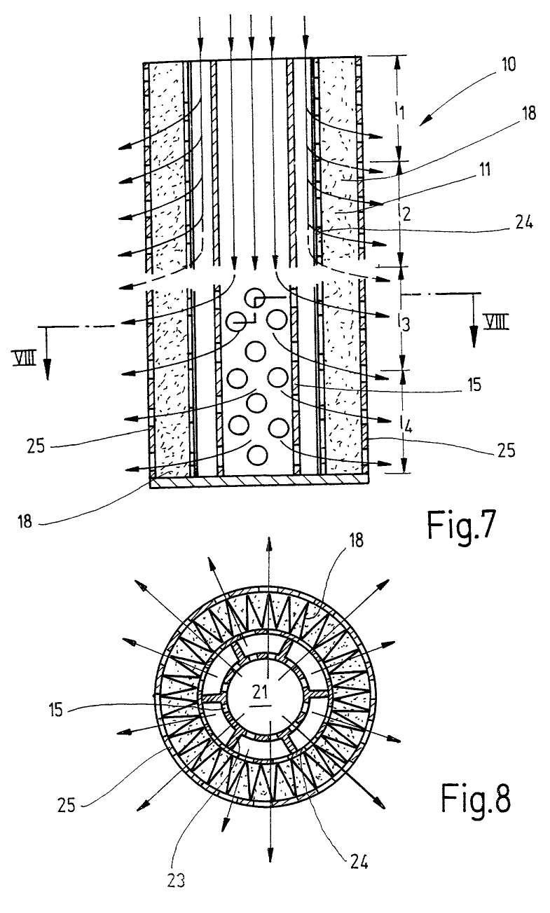

A back wash aid identified with a reference numeral 14 is arranged in the hollow chamber 13 for the back washing. The back wash aid 14 has a coaxial inner tube 15 which extends over the whole length of the filter element 10, and as the latter, is open at the upper end and closed at the lower end with the closure 12. The inner tube 15 is dimensioned and designed so that, at least at some locations it extends with a distance from the filtering material 11 and forms between the inner side of the filtering material 11 and the outer side of the inner tube 15, at least one intermediate chamber 16. It is known, for back washing in at least one intermediate chamber 16 formed between the inner tube 15 and the filtering material 11, to supply a back washing medium for back washing from the upwardly located open end in an arrow direction 17 in FIG. 1. Therefore it is provided that the filter element 10 can be back washed only in the upper region, which is dependent on the specifics of the filtering material. With the filtering material 11 which has very large upper surfaces and low resistances, such as for example folded or in particular plissed material shown in FIGS. 7 and 8, in particular fabric 18, these disadvantages are particularly significant, while such filtering materials 11 which are composed of wound material, for example of wound yarn, do not have such advantages pronounced, since they have a high initial resistance than a folded, in particular plissed fabric 18. However, even with such a filtering material 11, during back washing with the medium which is supplied into the intermediate chamber 16, a uniform back washing can not be obtained, since also then manually only the outer longitudinal region of the filter element 10 is back washed and cleaned fast.

With lowering of the resistance in this upper longitudinal region fo the filtering material 11 which was back washed, the back washing quantity which is available because of the reduced resistance of the filtering material 11 passes, and is not supplied into the lower region of the intermediate chamber 16 and from there inwardly and outwardly through the filtering element 11, so that substantially from the length center, starting substantially with one-third of the filtering material 11, the filtering material is insufficiently or not at all back washed and cleaned. This remaining part of the filtering material 11 remains covered with dirt. After ending of a back washing phase of this type, then during a filtering operation only the upper cleaned longitudinal region of the filtering material 11 is efficient for removing dirt. The filter element 10 with regard to the filtering capacity is substantially reduced, and in some conditions provides a filtering capacity of substantially 30%.

With the inventive design of the filter element 10, and in particular of the back wash aid 14 the efficiency is substantially increased. The inner tube 15 contains, substantially in its lower longitudinal region in the wall 19, throughgoing passages 20 which are formed for example as openings, boreholes and the like. This lower longitudinal region of the inner tube 14 provided with a throughgoing openings 20 can be for example half length of the whole length of the inner tube 15. For example, the longitudinal region which is provided with the throughgoing passages 20 can have the length substantially of 13+14, with the throughoing passages 20 located in the wall 19 substantially at the end of the half length of the inner tube 15 from the upper end 1. It is important that the part of the inner tube 15 located above in the wall 19 has no throughgoing passages, but instead the wall 19 is completely impermeable. The number, distribution and the through cross-section of the throughgoing openings 20 are different from time to time, and they are adjusted to a filtering medium over the filtering material 11.

For back washing of the filter element 10, in particular the filtering material 11, in accordance with the present invention, the back washing medium, in particular water and/or air, is supplied on the one hand in the arrow direction 17 into the at least one intermediate chamber 16. The back washing medium takes a course which is identified with the arrow 28. The back washing medium passes only at the upper longitudinal region of the filtering material 11 from inside outwardly and is there cleaned by back washing. In the lower end region of the longitudinal portion 12 it is identified with the broken arrow that there the back washing is not efficient by means of the medium supplied into the intermediate chamber 16 or is not provided at all.

Furthermore, during the back washing the back washing medium is supplied in the arrow direction 22 at the upper open end into the interior 21 of the inner tube 15. Since the upper longitudinal region of the inner tube 15 has no throughgoing passages in the wall 19, the back washing medium reaches in the interior 21 downwardly, where it passes in the region of the available throughgoing openings 20 in the arrow direction 32 through the throughgoing passages 20, through the intermediate chamber 16, and through the filtering material 11 with back washes the same outwardly. With a corresponding resistance compensation it is thereby guaranteed that the back washing medium which is supplied in correspondence with the arrow 17 from above into the intermediate chamber 16 back washes the upper longitudinal portion of the filtering material 11, while the back washing medium which is pumped in direction of the arrow 22 into the interior 21 of the inner tube 15 back washes through the throughgoing passages 20 of the lower longitudinal region of the filtering material 11 inwardly. The filter element 10, in particular the filtering material 11, is thereby back washed and cleaned over the whole length, and therefore back washing is obtained over the whole length. This leads to the fact, that after the corresponding back washing the filtering material 11 is cleaned over the whole length and during a new filtering operation has a full filtering capacity.

The inner tube 15 with regard to its cross-sectional shape and the tube dimensions is designed so that, inside the inner tube 15 its interior 21 and outside of the inner tube 15 between the latter and the filter material 11 in a first embodiment, such an intermediate chamber 16 is formed which is ring-shaped. The inner tube 15 in the first embodiment is circular in its cross-section, so that a ring-shaped intermediate chamber 16 is provided. The filtering material 11 has the shape of a tubular cylinder body and can be formed or built of different filter media, for example of wound yarn.

In the further embodiments shown in FIGS. 3-8 the parts that correspond to the parts of the first embodiment are identified with the same reference numerals so as to avoid repetition of the description of the first embodiment.

In the second embodiment shown in FIG. 3, the inner tube 15 is so designed with regard to its cross-sectional form and cross-sectional dimensions that between the inner tube 15 on the one hand and the inner side of the filtering material 11 on the other hand, several intermediate chambers 16 are formed. In the embodiment of FIG. 3 there are three such intermediate chambers 16. The inner tube 15 of FIG. 3 has a polygonal cross-section, and in particular here a triangular cross-section, and therefore it is composed of a triangular tube. It is dimensioned with respect to its transverse dimensions so that, the inner tube 15 abuts substantially on the inner side of the filtering material 11 along the whole length of the filter element 10. The three walls of the triangular inner tube 15 and the inner side of the filtering material 11 foum correspondingly shaped intermediate chambers 16. These three intermediate chambers 16 are arranged at substantially uniform peripheral angular distances. They have substantially the same volumes. In accordance with a different embodiment, the inner tube has a star shape instead of the one shown in the drawing.

For the second embodiment shown in FIG. 3, the same is true as for the first embodiment, that with the volume of the at least one intermediate chamber 16, or in the embodiment of FIG. 3 the volume sum, of the intermediate chambers 16, is smaller than the volume of the interior 21 of the inner tube 15.

In the third embodiment shown in FIG. 4, the inner tube 15 is designed basically similarly to the inner tube of the embodiment of FIG. 3. It has a polygonal cross-section and in particular four-cornered cross-section so as to provide four walls 19. Here also the intermediate chambers 16 are arranged at substantially identical peripheral angular distances, and they have substantially identical volumes. The volume sum of all four intermediate chambers 16 is smaller than the volume in the interior 21 of the inner tube 15 which has a four-cornered cross-section.

The both embodiments of FIGS. 3 and 4 have the common feature that the polygonal inner tube performs two functions. On the one hand, it forms with its interior 21 the corresponding inner chamber which is connected to the intermediate chambers 16 in the lower longitudinal region through the throughgoing passages 20 in the walls 19, and on the other hand provides with the walls 19 simultaneously partitions which extend along a corresponding secant in the interior of the filtering material 11 and thereby subdivides the ring-shaped intermediate chamber into wheel chambers 16.

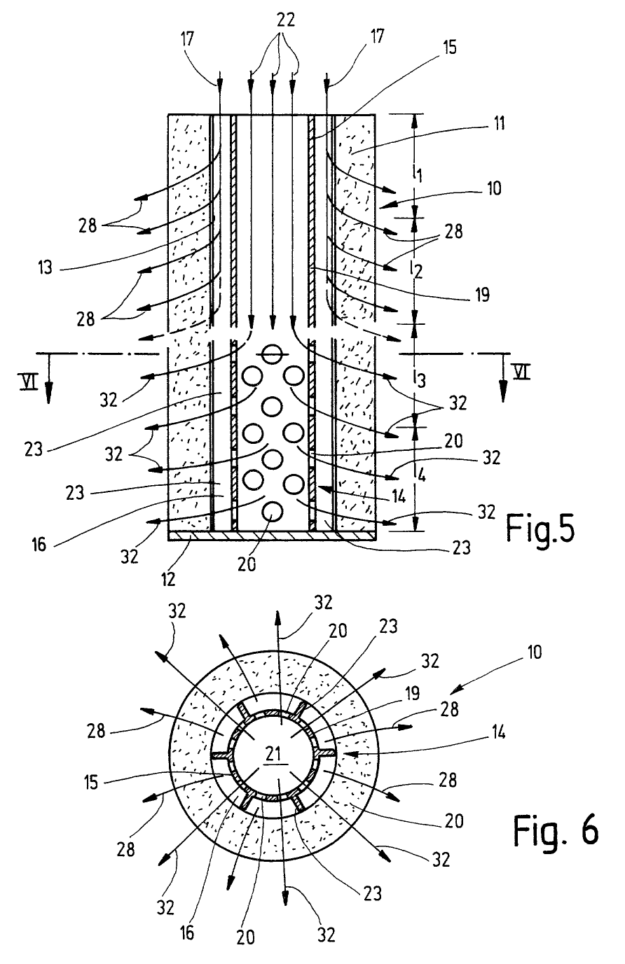

The fourth embodiment of FIGS. 5 and 6 differs from the first embodiment in that, the ring-shaped intermediate chamber 16 of the first embodiment is subdivided by radial partitions 23 into individual chambers, which are arranged at substantially identical peripheral angular distances and have substantially identical volumes. The volume sum of all chambers 16 is smaller than the volume of the interior 21 of the inner tube 15. As can be seen, the radial partitions 23 are located at the outward side of the inner tube 15. They can be formed as separate parts which are fixed on the inner tube 15, or instead can be formed of one piece with the inner tube 15.

The advantage of the design in accordance with FIGS. 3-6 is that, the corresponding inner tube 15 abuts either with the cross-sectional corners (FIGS. 3 and 4) or with the ends of the radial partition 23 against the inner side of the filtering material 11, operates as a support of the inner-side reinforcement of the filtering material 11, when the filtering material 11 requires such an inner support because of its properties.

The fifth embodiment of FIGS. 7 and 8 is different from the fourth embodiment of FIGS. 5 and 6 in that, the filtering material 11 has a folded, in particular, plissed material, particularly of fabric 18 as a filtering medium. The filtering material 11 has at least one permeable supporting body 24, 25. The at least one supporting body 24, 25 is formed of a tube provided with throughgoing passages. A perforated tube is provided at the inner side of the filtering material 11 as an inner supporting body 24, and an outer supporting body 25 also formed as a perforated tube is provided at the outer side of the filtering material 11. Both supporting bodies 24 and 25 provide the filtering material 11 with the required hold in form of the folded fabric 18. Otherwise, the filter element 10 of FIGS. 7 and 8 corresponds to that of FIGS. 5 and 6 and also to that of FIG. 1. In deviation from the latter, the inner tube 15 is designed however with a radial partitions 23. The embodiment of FIGS. 5 and 6 or FIGS. 7 and 8 has a special advantage that in this manner, also an available filter element without an inner tube 15 can be upgraded in simple manner by the later insertion of the thusly designed inner tube 15.

In accordance with a further not shown embodiment, the partitions, for example such which are formed analogously to the walls 19 in FIGS. 3 and 4 and extend along secant, can be formed by the walls of an additional tube, for example by a tube with a polygonal cross-section, for example a triangular cross-section or a four-cornered cross-section. This additional tube can be placed on the inner tube 15 and surrounds the latter.

When for example for further upgrading for forming the inner tube 15 only such must be available, which are provided over their whole tube length with throughgoing openings 20 in the wall 19, it is possible to cover the throughgoing passages located on the upper first substantially half longitudinal portion of this tube, for example by insertion of an additional tube and thereby to close them. This additional, the inwardly insertable tube in the wall can have no throughgoing passages. It can extend relative to the length, for example only through the upper for example substantially half longitudinal region of the inner tube 15 provided with the throughgoing passages 20. Instead, naturally an additional tube of the same length can be inserted in the inner tube 15. This additional tube can have then no throughgoing passages in the wall substantially over the upper half longitudinal region, while the lower substantially half longitudinal region is provided with throughgoing passages in the wall, which communicate with throughgoing passages 20 in the wall 19 of the inner tube 15.

It will be understood that each of the elements described above, or two or more together, may also find a useful application in other types of constructions differing from the types described above.

While the invention has been illustrated and described as embodied in tubular filter element, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A tubular filter element, comprising a filtering material extending over a whole length and having in its interior a hollow chamber so that during a filtering operation said filtering material is loaded from outside with a medium to be filtered which passes through said filtering material from outside inwardly to said hollow chamber; a back wash aid arranged in said hollow chamber; a coaxial inner tube located in said hollow chamber of said filtering material and arranged at least at some locations with a distance from said filtering material so as to form at least one intermediate chamber, said inner tube having a tubular wall and being provided at least substantially in a lower longitudinal region with throughgoing passages extending through said tube wall and formed so that, for back washing of said filtering material a back washing medium is supplied opposite to a filtering operation on the one hand into an interior of said inner tube and through said throughgoing passages and on the other hand also into said at least one intermediate chamber and from the latter from inside outwardly through said filtering material.

2. A tubular filter element as defined in claim 1, wherein said at least one intermediate chamber has a volume which is smaller than a volume of said interior of said inner tube.

3. A tubular filter element as defined in claim 1, wherein said lower longitudinal region of said inner tube provided with said throughgoing passages is substantially half of a whole length of said inner tube.

4. A tubular filter element as defined in claim 1, wherein said inner tube has a cross-sectional shape and/or a cross-sectional size such that inside said inner tube its interior and outside said inner tube between said inner tube and said filtering material several such intermediate chambers are formed.

5. A tubular filter element as defined in claim 1, wherein said inner tube has a cross-section selected from the group consisting of a polygonal cross-section, a star cross-section, a triangular cross-section, a four-corner cross-section, said inner tube having such a cross-sectional size that said inner tube with cross-sectional corners abut against an inner side of said filtering material, and said intermediate chamber is limited by walls of said inner tube and an inner side of said filtering material.

6. A tubular filter element as defined in claim 5, wherein said inner tube has a circular cross-section, said inner wall and an inner side of said filtering material forming said intermediate chamber as a ring-shaped intermediate chamber.

7. A tubular filter element as defined in claim 6; and further comprising partitions which subdivide said tubular intermediate chamber into a plurality of individual chambers.

8. A tubular filter element as defined in claim 7, wherein said partitions extend in a direction selected from the group consisting of a radial direction or a direction along corresponding secants.

9. A tubular filter element as defined in claim 7, wherein said partitions are arranged on an outer side of said inner tube.

10. A tubular filter element as defined in claim 7, wherein said partitions are formed by walls of a tube which surrounds said inner tube.

11. A tubular filter element as defined in claim 7, wherein said partitions are arranged on said inner tube in a manner selected from the group consisting of mounting on said inner tube or being formed of one piece with said inner tube.

12. A tubular filter element as defined in claim 4, wherein said intermediate chambers are arranged at substantially identical peripheral angular distances.

13. A tubular filter element as defined in claim 4, wherein said intermediate chambers have substantially identical volumes.

14. A tubular filter element as defined in claim 1, wherein said filtering material is formed as a tubular cylinder body.

15. A tubular filter element as defined in claim 1, wherein said filtering material is formed as a wound element of a filtering medium.

16. A tubular filter element as defined in claim 15, wherein said filtering material is formed as a wound yarn as a filtering medium.

17. A tubular filter element as defined in claim 1, wherein said filtering material is formed as a folded material which forms a filtering medium.

18. A tubular filter element as defined in claim 17, wherein said filtering material is formed as a plissed material which is fabric.

19. A tubular filter element as defined in claim 1, wherein said filtering material has at least one permeable supporting body.

20. A tubular filter element as defined in claim 19, wherein said at least one supporting body is formed as a tube provided with throughgoing passages.

21. A tubular filter element as defined in claim 19, wherein said supporting body is formed as a tube provided with throughgoing passages and arranged at a side selected from the group consisting of an inner side, an outer side, and both of said filtering material.

22. A tubular filter element as defined in claim 1, wherein said filtering material is formed as a folded fabric.
